(19) United States
(12) Patent Application Publication
(10) Pub. No.: US 2011/0089790 A1
(43) Pub. Date: Apr. 21, 2011

(54) Refrigerator and method of manufacturing the same

(75) Inventors: Hyoung Suk Lee, Daejeon (KR); Hyo Sik Kang, Gwangiu (KR); Sang Chul Ryu, Gwangiu (KR); Young Gwi Park, Gwangiu (KR)

(73) Assignee: SAMSUNG ELECTRONICS CO., LTD., Suwon (KR)

(21) Appl. No.: 12/923,686

(22) Filed: Oct. 4, 2010

(30) Foreign Application Priority Data
Oct. 20, 2009 (KR) 10-2009-99619

(51) Int. Cl. F25D 23/02; A47B 97/00; A47B 87/00; B23P 15/26

(52) U.S. Cl. 312/109; 312/204; 312/405; 29/890.035

(57) ABSTRACT

A refrigerator and a method of manufacturing the same include a door that opens and closes a storage chamber. The door includes a frame, and a panel fixed to the frame. An end of the panel is supported by the frame on one or two sides thereof. Accordingly, manufacturing processes are simplified while the design of the refrigerator is optimized.

### CROSS-REFERENCE TO RELATED APPLICATIONS

This application claims the benefit of Korean Patent Application No. 2009-0099619, filed on Oct. 20, 2009 in the Korean Intellectual Property Office, the disclosure of which is incorporated herein by reference.

### BACKGROUND

1. Field

Embodiments relate to a refrigerator having a decorative member and a method of manufacturing the same.

2. Description of the Related Art

Generally, a refrigerator refers to an apparatus to maintain freshness of items stored therein by supplying cold air into a storage chamber. These days, refrigerators also function as interior design elements, like furniture. In particular, decorations such as pictures and patterns may be attached to a refrigerator door, thereby supplying designs to users.

The refrigerator door includes a frame, a front panel connected to a front of the frame, a rear frame connected to a rear of the frame, a decorative member attached to the front panel, and a chassis fixing the decorative member.

The refrigerator door is constructed through a plurality of assembly processes. The processes include attaching the respective panels to the frame, applying a foamed material to obtain an adiabatic effect, and connecting the decorative member to enhance the design of the refrigerator.

### SUMMARY

Therefore, it is an aspect of example embodiments to provide a refrigerator having a maximized design effect by improving an assembly structure of a door thereof.

It is another aspect of example embodiments to provide a method of manufacturing a refrigerator, capable of simplifying the assembly processes of a door of the refrigerator.

Additional aspects will be set forth in part in the description which follows and, in part, will be apparent from the description, or may be learned by practice of the embodiments.

The foregoing and/or other aspects are achieved by a refrigerator including a main body including a storage chamber, and a door opening and closing the storage chamber, the door includes a frame; a decorative panel supported by the frame; a decoration unit supported by the decorative panel; and a foamed material that fixes the decorative panel to the frame and fixes the decoration unit to the decorative panel.

The decorative panel may cover a front side of the frame.

The decorative panel may be temporarily fixed to the frame by a first adhesive material before being fixed by the foamed material.

The decoration unit may be temporarily fixed to the decorative panel by a second adhesive material before being fixed by the foamed material.

The decoration unit may include a jewel member or a light emission member.

The decoration unit may further include a supporting plate to support the jewel member or the light emission member.

The frame may support one side or two sides of an end of the decorative panel.

The frame may include a panel seating part that supports the decorative panel, and the panel seating part supports a lower surface of an end of the decorative panel but does not support a side surface and an upper surface of the end of the decorative panel.

The frame may include a panel seating part and a position fixing protrusion that support the decorative panel, the panel seating part may support a lower surface of an end of the decorative panel, and the position fixing protrusion may include support a side surface of the end of the decorative panel but does not support an upper surface of the decorative panel.

The decorative panel may include a flat part and a rolled part stepped with respect to the flat part, and further includes a stepped part compensation member mounted along the rolled part to compensate for the stepped part.

The rolled part of the decorative panel may be supported by the frame on one side or two sides thereof.

The frame may include a panel seating part that supports the decorative panel, and the panel seating part supports a lower surface of an end of the decorative panel and the stepped part compensation member but does not support a side surface and an upper surface of the end of the decorative panel.

The frame may include a panel seating part and a position fixing protrusion that support the decorative panel, the panel seating part supports a lower surface of an end of the decorative panel and the stepped part compensation member, and the position fixing protrusion supports a side surface of the end of the decorative panel but does not support an upper surface of the decorative panel.

The frame may be integrally injection-molded.

The frame may be an assembly constructed by a plurality of chasses.

The foregoing and/or other aspects are achieved by a method of manufacturing a refrigerator having a door that opens and closes a storage chamber, wherein the door includes a frame; a decorative panel supported by the frame; and a decoration unit supported by the decorative panel, and the decoration unit is fixed to the decorative panel and the decorative panel is fixed to the frame by a bonding force of a foamed material.

The decoration unit may be temporarily fixed to the decorative panel by a dedicated adhesive material before being fixed by the foamed material.

The decorative panel may be temporarily fixed to the decorative panel by a dedicated adhesive material before being fixed by the foamed material.

The foregoing and/or other aspects are achieved by a refrigerator including a main body including a storage chamber; and a door opening and closing the storage chamber, wherein the door includes a frame; and a panel fixed to the frame, and the panel is sequentially fixed to the frame by an adhesive material and a foamed material, in this order, and is disposed at a front side of the frame, to prevent the front side of the frame from being exposed.

The frame may include a panel seating part supporting the panel, and the panel seating part may support a lower surface of the end of the panel but does not support a side surface and an upper surface of the panel when the end of the panel is supported by the frame on one side thereof.

The side surface of the panel and a side surface of an end of the frame may be coplanar.

The frame may include a panel seating part and a position fixing protrusion which support the panel. When the panel is supported by the frame on two sides thereof, the panel seating part may support a lower surface of the end of the panel, and the position fixing protrusion may support a side surface of the end of the panel but does not support an upper surface of the panel.

The upper surface of the end of the panel and an upper surface of an end of the frame may be coplanar.

The panel may include a decorative panel mounted to a front side of the frame.

The manufacturing method may further include a decoration unit disposed at a rear surface of the panel.

The decoration unit may include a jewel member or a light emission member; and a supporting plate fixed to the panel while supporting the jewel member or the light emission member.

The panel may include a flat part and a rolled part stepped with respect to the flat part, and may further include a stepped part compensation member mounted along the rolled part to compensate for the stepped part.

The rolled part and the stepped part compensation member may be supported by the frame on either one side or two sides of the frame.

The panel may be fixed to the frame by a bonding force of the foamed material.

The foregoing and/or other aspects are achieved by a door of a refrigerator includes a frame; a decorative panel connected to the frame, and an end of the frame is disposed on a side surface or a lower surface of each end of the decorative panel.

The foregoing and/or other aspects are achieved by a method of manufacturing a refrigerator having a door that opens and closes a storage chamber, the door may be constructed by supporting a decoration unit on a decorative panel; and supporting the decorative panel on a frame, and the decoration unit may be fixed to the decorative panel and the decorative panel is fixed to the frame by a bonding force of a foamed material.

The foregoing and/or other aspects are achieved by a refrigerator having at least one door, the door including a frame; a front panel supported by the frame; and a foamed material that fixes the front panel to the frame, and the front panel is temporarily joined to the frame by a temporary joining member before being fixed by the foamed material without further fixing members to the frame.

The refrigerator may include a decoration unit which is joined to the back of the front panel by a temporary joining member before the foamed material fixes the front panel to the frame.

The front panel may be made of substances including wood, tempered glass, acrylic, aluminum, and steel plate.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a front view of a refrigerator according to an embodiment;

FIG. 2 is a perspective view of the refrigerator according to the embodiment;

FIG. 3 is a side-sectional view of a door of the refrigerator;

FIG. 4 is an exploded perspective view of the door;

FIG. 5 is another exploded perspective view of the door;

FIG. 6 is a sectional view of the door, wherein a decorative panel may be made of tempered glass and a position fixing protrusion is omitted;

FIG. 7 is a sectional view of the door, wherein the decorative panel may be made of tempered glass and a position fixing protrusion is included;

FIG. 8 is a sectional view of the door, wherein a decorative panel may be made of steel and a position fixing protrusion is omitted; and

FIG. 9 is a sectional view of the door, wherein the decorative panel may be made of steel and a position fixing protrusion is included.

### DETAILED DESCRIPTION

Reference will now be made in detail to the embodiments, examples of which are illustrated in the accompanying drawings, wherein like reference numerals refer to like elements throughout.

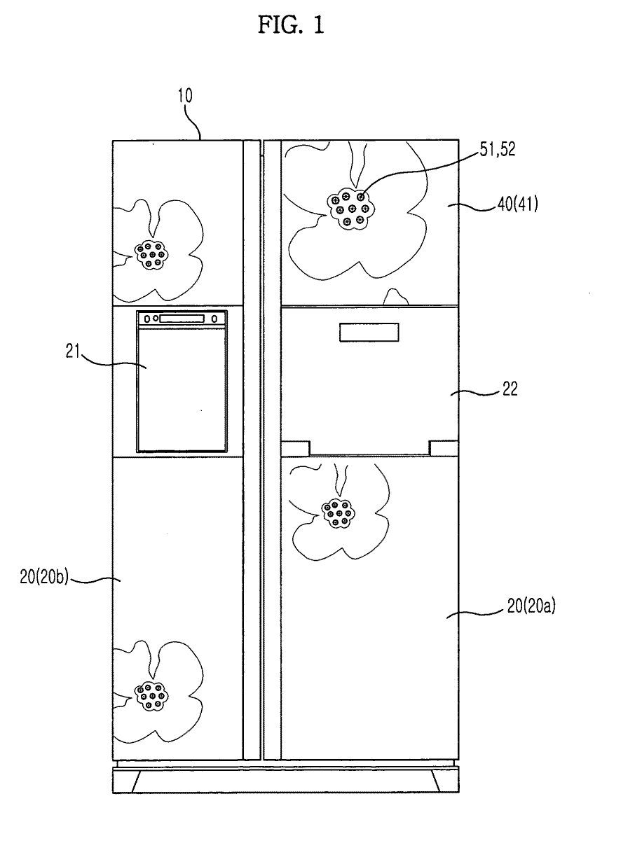

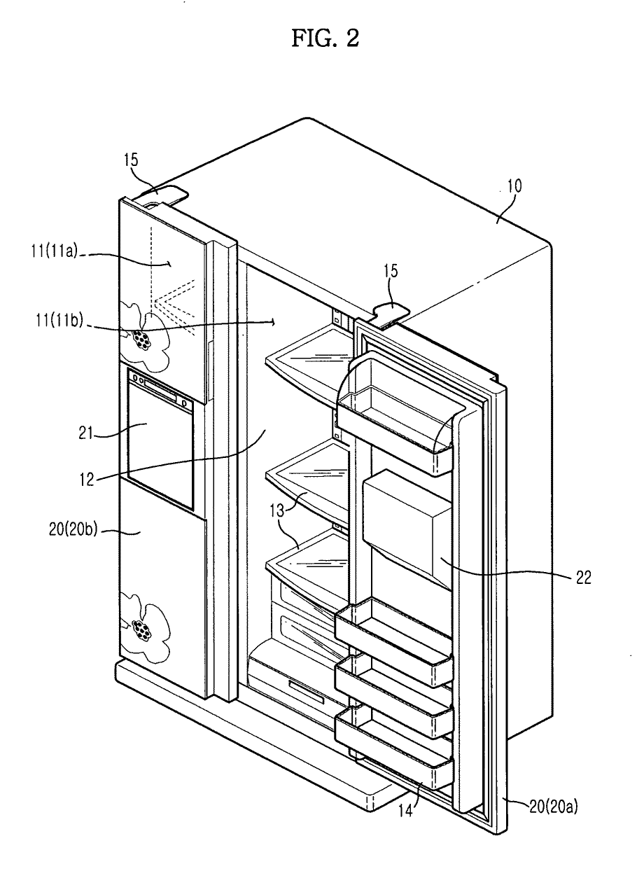

FIG. 1 is a perspective view of a refrigerator according to an embodiment. FIG. 2 is a perspective view of the refrigerator.

FIG. 1 shows a state wherein a refrigerating chamber door 20a and a freezing chamber door 20b are closed. FIG. 2 shows a state wherein the freezing chamber door 20b is opened. The refrigerator may include a main body 10 containing a storage chamber 11 therein, and a door 20 opening and closing the storage chamber 11. The storage chamber 11 may be divided into a refrigerating chamber 11a and a freezing chamber 11b by a partition 12. The refrigerating chamber 11a is opened and closed by the refrigerating chamber door 20a while the freezing chamber 11b is opened and closed by the freezing chamber door 20b. The doors 20a and 20b may be pivotably connected to the main body 10 through hinge devices 15.

A plurality of shelves 13 may be mounted in the storage chamber 11. A rack 14 may be mounted to the refrigerating chamber door 20a to receive beverage bottles or the like. In an embodiment, the refrigerating chamber door 20a may further include a home bar 22 enabling a user to take out beverage bottles therefrom. Also, the freezing chamber door 20b may include a dispenser 21 enabling the user to take out water or ice therethrough.

Hereinafter, the refrigerating chamber door 20a and the freezing chamber door 20b will be collectively referred to as a “door 20” so long as differentiation therebetween is not necessary.

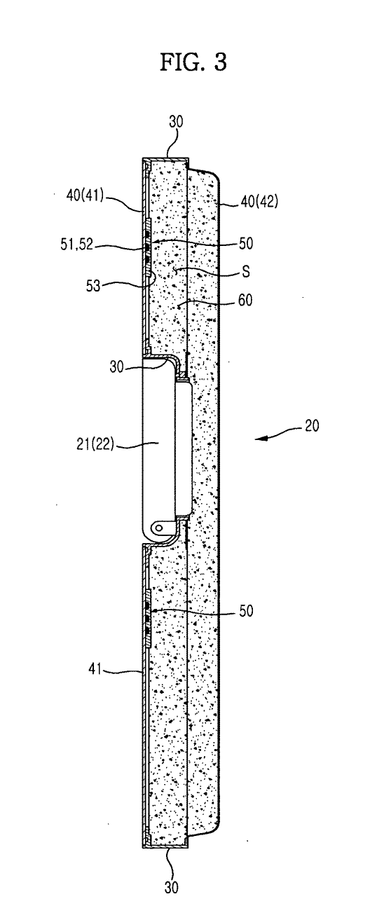

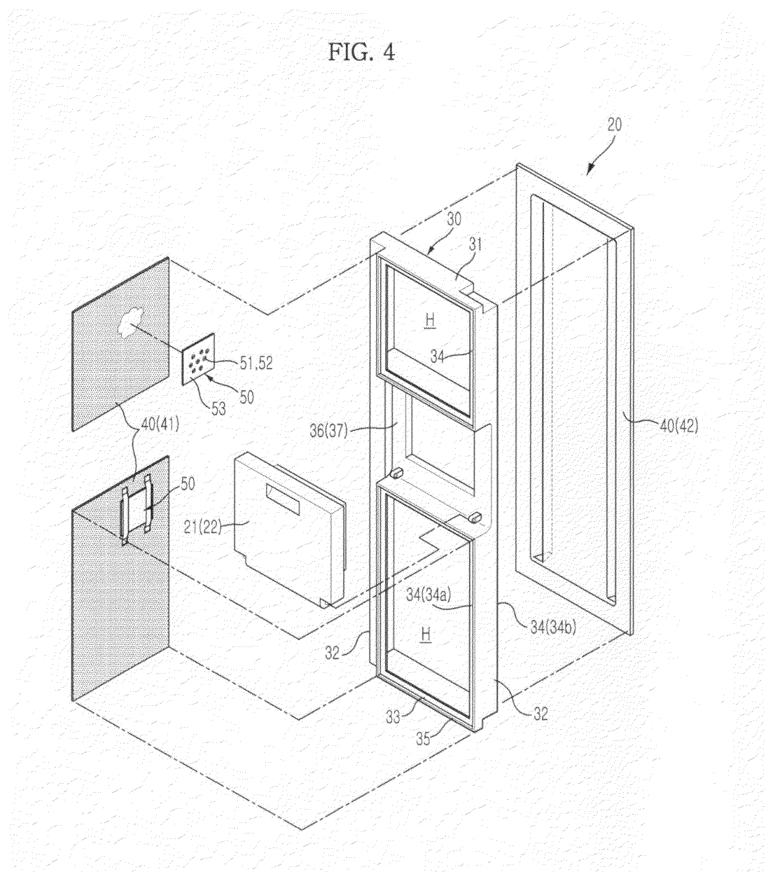

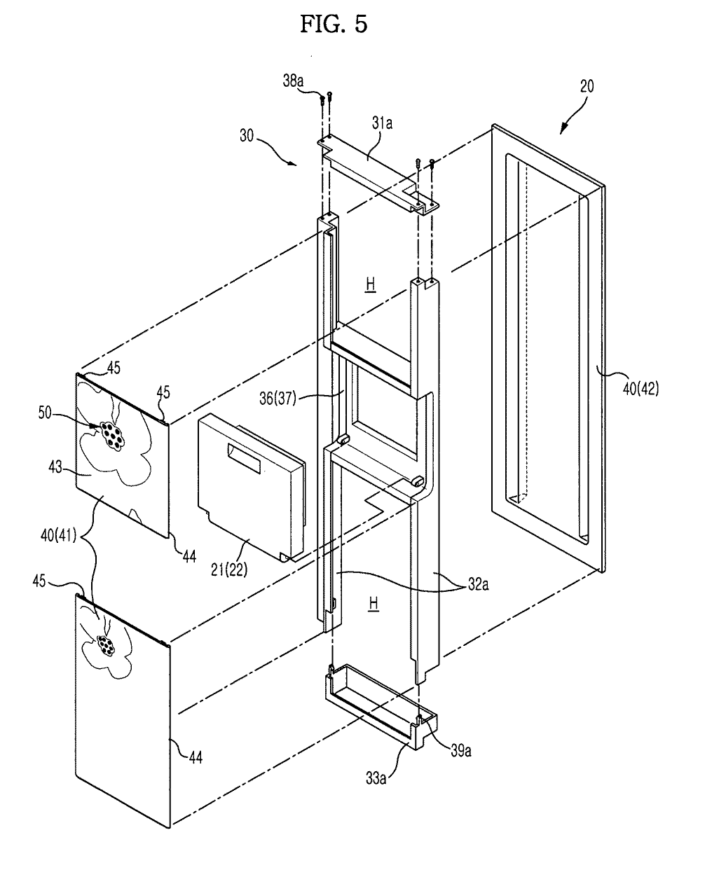

FIG. 3 is a side-sectional view of a door of the refrigerator. FIG. 4 and FIG. 5 are exploded perspective views of the door.

Referring to FIG. 3 to FIG. 5, the door 20 includes a frame 30, and a panel 40 connected to the frame 30. The panel 40 may include a front panel 41 disposed at the front of the frame 30 and a rear panel 42 disposed at the rear of the frame 30.

As shown in FIG. 4, the frame 30 may have an integrated form through injection molding. Such an integrated frame 30 supplies a framework for the door 20 through a single injection molding process without necessitating any further processes. An upper side 31, a lower side 33, and both lateral sides 32 of the frame 30 may be formed integrally. A plurality of openings H may be formed at the inside of the frame 30.

The frame 30 may include a panel seating part 34 formed along the periphery thereof. The panel seating part 34 includes a front panel seating part 34a disposed on the front of the frame 30 and a rear panel seating part 34b disposed on the rear of the frame 30. The front panel 41 and the rear panel 42 may be temporarily fixed to the front panel seating part 34a and the rear panel seating part 34b, respectively, through an adhesive material such as double-sided tape. In this case, movement of the front and the rear panels 41 and 42 is prevented before the panels 41 and 42 are fixed to the frame 30 by a bonding force of a foamed material which will be foamed later.

In addition, the frame 30 may further include a position fixing protrusion 35 formed along the periphery thereof. The position fixing protrusion 35 guides and supports the front and the rear panels 41 and 42 so that the panels 41 and 42 are disposed at correct positions on the frame 30 without causing a positioning error.

The frame 30 may further include a home bar receiving part 36 or a dispenser receiving part 37. Although not shown, a display mounting part may also be further provided.

The front panel 41 may be attached to the front of the frame 30, to function as a decorative panel. Wood, tempered glass, acrylic, aluminum, colored steel plate and the like may be used for the decorative front panel 41. FIG. 4 shows an example wherein the decorative panel 41 is made of tempered glass. The decorative panel 41 may be used as it is, that is, in a flat form since tempered glass is not sharp-edged. The decorative panel 41 is printed with patterns such as pictures, thereby providing the refrigerator with the design effect. It is noted that the front panel 41, the decorative front panel 41, and the decorative panel 41 used herein all refer to the same element although they may be differentiatingly used.

A decoration unit 50 may be attached to a rear surface of the decorative panel 41. The decoration unit 50 may include a jewel member 51, and a supporting plate 53 supporting the jewel member 51. The jewel member 51 includes jewels that are colored and lustrous minerals to supply the design in harmony with the decorative panel 41. The supporting plate 53 may be attached to the decorative panel 41 using an adhesive material such as double-sided tape so that the jewel member 51 is correctly mounted on the decorative panel 41. Accordingly, the decoration unit 50 is prevented from moving before being fixed to the decorative panel 41 by the bonding force of the foamed material.

Additionally, the decoration unit 50 may include a light emission member 52. The light emission member 52 may include a light emitting diode (LED) and may be used along with or replace the jewel member 51. The light emission member 52 may have the same supporting structure as the jewel member 51.

The rear panel 42 may be attached to the rear side of the frame 30, for example, being formed of plastic, synthetic resin, rubber, wood, tempered glass, acrylic, aluminum or colored steel plate.

As shown in FIG. 5, the frame 30 may form a single assembly. The frame assembly 30 includes an upper chassis 31a, both side chasses 32a and a lower chassis 33a constructing the framework of the door 20. The upper, the side and the lower chasses 31a, 32a and 33a may be connected through a screw connection structure 38a or a hook connection structure 39a.

Since the front panel 41, the rear panel 42 and the decoration unit 50 shown in FIG. 5 are the same as described in FIG. 4, a detailed description thereof will be omitted.

In FIG. 5, the front panel 41, that is, the decorative panel 41 may be formed of a steel plate. Since the steel plate has sharp edges, edges of the steel plate may be rolled in. The decorative panel 41 includes a flat part 43 in the form of a flat plane, and a rolled part 44, the edge of which is rolled. Here, a supported area of the frame 30 may be reduced because the flat part 43 and the rolled part 44 form a stepped structure. To this end, a stepped part compensation member 45 may be mounted along the rolled part 44 to compensate for the reduced supported area.

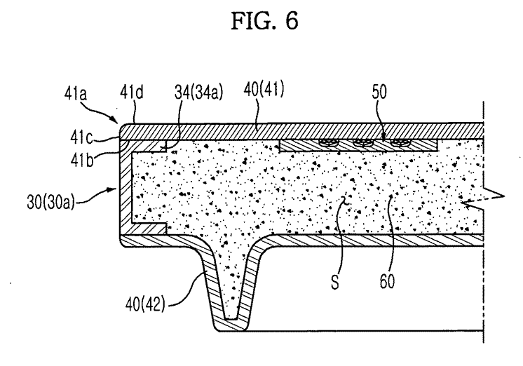

FIGS. 6 to 9 are sectional views of the door according to embodiments.

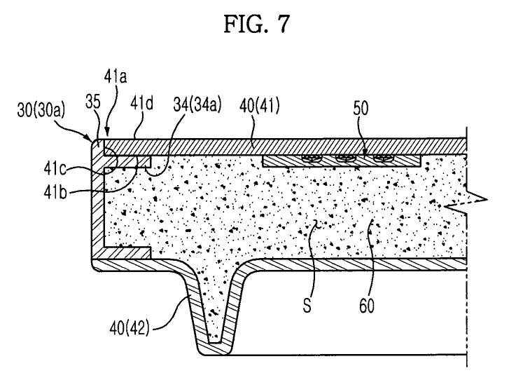

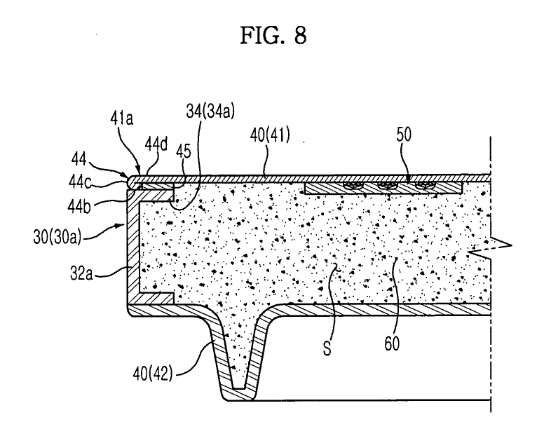

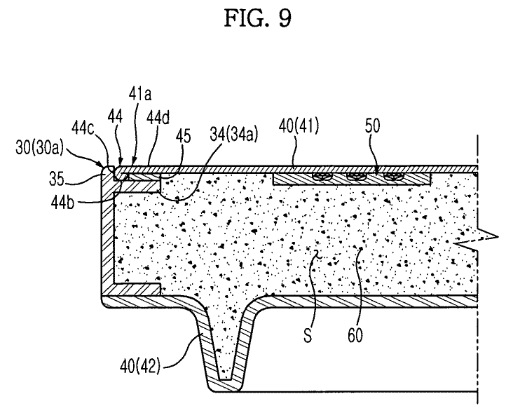

In FIG. 6, the decorative panel 41 may be formed of tempered glass and a position fixing protrusion is omitted. In FIG. 7, the decorative panel may be made of tempered glass and a position fixing protrusion 35 is included. In FIG. 8, the decorative panel may be made of a steel plate and a position fixing protrusion is omitted. In FIG. 9, the decorative panel may be made of a steel plate and the position fixing protrusion 35 is included.

When the decorative panel 41 is supported at the front side of the frame 30 and the rear panel 42 is supported at the rear side of the frame 30, a foaming space S may be generated between the decorative panel 41 and the rear panel 42. As the foaming space S is charged with a foamed material 60, the decorative panel 41 is fixed to the front side of the frame 30 by a bonding force of the foamed material 60. Also, the rear panel 42 is fixed to the rear side of the frame 30 by the foamed material 60. Here, the foamed material 60 may include asbestos, glass fiber, cork, foamed plastic and so on, having a low thermal conductivity, so as to obtain an adiabatic effect. In an embodiment, the foamed material 60 may be implemented by urethane which chemically reacts and swells in a liquid state, and cures in a predetermined time, thereby generating a bonding force.

As shown in FIG. 6, an end 41a of the decorative panel 41 and an end 30a of the frame 30 are disposed at upper and lower positions, so that the end 41a of the decorative panel 41 is supported by the frame 30 on one side thereof. More specifically, a lower surface 41b of the end 41a of the decorative panel 41 may be supported by the front panel seating part 34a whereas a side surface 41c and an upper surface 41d of the end 41a are not supported. Here, the end 41a of the decorative panel 41 and the end 30a of the frame 30 may be coplanar.

The above structure is practicable since the decorative panel 41 is fixed to the frame 30 by the bonding force of the foamed material 60. Also, since no stepped part is generated at corners of the assembly of the decorative panel 41 and the frame 30, the design advantages or effects may be maximized. The rear panel 42 may be supported by the frame 30 in the same manner as the decorative panel 41 as described above.

Referring to FIG. 7, the end 41a of the decorative panel 41 and the end 30a of the frame 30 may be disposed at left and right positions, so that the end 41a of the decorative panel 41 is supported by the frame 30 on two sides thereof. More specifically, the lower surface 41b of the end 41a of the decorative panel 41 may be supported by the front panel seating part 34a, and the side surface 41c of the end 41a may be supported by the position fixing protrusion 35 while the upper surface 41d of the end 41a is not supported. In this case, the end 41a of the decorative panel 41 and the end 30a of the frame 30 may be coplanar.

Also, the above structure is practical since the decorative panel 41 is fixed to the frame 30 by the bonding force of the foamed material 60. Further, the position fixing protrusion 35 may have a height equivalent to a thickness of the decorative panel 41. According to this, a stepped part is not generated at corners of the assembly of the decorative panel 41 and the frame 30, thereby maximizing aesthetics. The rear panel 42 may be supported by the frame 30 in the same manner as the decorative panel 41.

Meanwhile, as shown in FIG. 8, the end 41a of the decorative panel 41 and the end 30a of the frame 30 may be disposed at upper and lower positions, so that the end 41a of the decorative panel 41 is supported by the frame 30 on one side thereof. However, since the rolled part 44 and the stepped part compensation member 45 are supported by the front panel seating part 34a, the stepped part compensation member 45 is capable of securely obtaining the supported area of the decorative panel 41. In this state, a lower surface 44b of the decorative panel 41 and the stepped part compensation member 45 are supported by the front panel seating part 34a while a side surface 44c and an upper surface 44d of the rolled part 44 of the decorative panel 41 are not supported. The other structures are the same as described with reference to FIG. 6 and therefore will not be repeatedly explained.

In addition, the end 41a of the decorative panel 41 and the end 30a of the frame 30 may be disposed on left and right positions so that the end 41a of the decorative panel 41 is supported by the frame 30 on two sides thereof, as shown in FIG. 9. Since the rolled part 44 and the stepped part compensation member 45 are supported by the front panel seating part 34a, the stepped part compensation member 45 is capable of securely obtaining the supported area of the decorative panel 41. In this state, the lower surface 44b of the rolled part 44 of the decorative panel 41 and the stepped part compensation member 45 are supported by the front panel seating part 34a while the side surface 44c of the rolled part 44 is supported by the position fixing protrusion 35. However, the upper surface 44d of the rolled part 44 is not supported. The other structures are the same as described with reference to FIG. 7, and therefore will not be repeatedly explained.

Hereinafter, a method of manufacturing the door according to the above embodiment will be described in detail with reference to FIG. 1 to FIG. 9.

Referring to FIG. 4 and FIG. 5, the door 20 is constructed using the frame 30. The frame 30 may be formed into an integrated structure by injection molding as shown in FIG. 4, or may be formed into an assembly as shown in FIG. 5.

The panel 40 may be prepared to include wood, tempered glass, acrylic, aluminum and colored steel plate. The panel 40 may include a decorative panel 41 and a rear panel 42. The decorative panel 41 may be printed with decorative patterns.

The decoration unit 50 may be prepared, including the jewel member 51 or the light emission member 52, and the supporting plate 53 supporting the jewel member 51 or the light emission member 52.

The decoration unit 50 may be attached to the rear surface of the decorative panel 41. Here, an adhesive material such as double-sided tape may be used to correctly mount the decoration unit 50.

The decorative panel 41 attached with the decoration unit 50 may be attached to the front side of the frame 30. An adhesive material such as double-sided tape may be used to correctly mount the decorative panel 41. The rear panel 42 may be attached to the rear side of the frame 30, using the double-sided tape and/or a hook connection structure. The decorative panel 41, the rear panel 42, and the frame 30 form the foaming space S. The connection structure between the end 41a of the decorative panel 41 and the frame 30 is already explained above with reference to FIGS. 6 to 9.

The foamed material 60 may fill the foaming space S. The foamed material 60 may include urethane and have a bonding force. The bonding force of the foamed material 60 enables the decorative panel 41 and the rear panel 42 to be fixed to the frame 30. Also, the decoration unit 50 may be fixed to the decorative panel 41 by the bonding force of the foamed material 60.

Accordingly, the refrigerator does not require a dedicated fixing device to fix the decorative panel 41 to the frame 30 and fix the decoration unit 50 to the decorative panel 41. As a result, material cost and the number of manufacturing processes are reduced, thereby improving productivity. Furthermore, since the supporting structure of the decorative panel 41 and the frame 30 is improved, the design of the refrigerator is enhanced.

As is apparent from the above description, a refrigerator according to the embodiment is capable of reducing the number of parts, simplifying the assembly processes, and accordingly reducing manufacturing costs. Consequently, productivity is improved.

Moreover, the simplified structure optimizes the design of the refrigerator.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A refrigerator comprising a main body including a storage chamber, and a door opening and closing the storage chamber,
the door comprising:
a frame;
a decorative panel supported by the frame;
a decoration unit supported by the decorative panel; and
a foamed material that fixes the decorative panel to the frame and fixes the decoration unit to the decorative panel, wherein,
the decorative panel is temporarily fixed to the frame by a first adhesive material before being fixed by the foamed material, and
the decoration unit is temporarily fixed to the decorative panel by a second adhesive material before being fixed by the foamed material.

2. The refrigerator according to claim 1, wherein the decorative panel covers a front side of the frame.

3. The refrigerator according to claim 1, wherein the decoration unit comprises a jewel member or a light emission member.

4. The refrigerator according to claim 3, wherein the decoration unit further comprises a supporting plate to support the jewel member or the light emission member.

5. The refrigerator according to claim 1, wherein the frame supports one side or two sides of an end of the decorative panel.

6. The refrigerator according to claim 1, wherein the frame comprises a panel seating part that supports the decorative panel, and
the panel seating part supports a lower surface of an end of the decorative panel but does not support a side surface and an upper surface of the end of the decorative panel.

7. The refrigerator according to claim 1, wherein the frame comprises a panel seating part and a position fixing protrusion that support the decorative panel,
the panel seating part supports a lower surface of an end of the decorative panel, and
the position fixing protrusion supports a side surface of the end of the decorative panel but does not support an upper surface of the decorative panel.

8. The refrigerator according to claim 1, wherein the decorative panel comprises a flat part and a rolled part stepped with respect to the flat part, and further comprises a stepped part compensation member mounted along the rolled part to compensate for the stepped part.

9. The refrigerator according to claim 8, wherein the rolled part of the decorative panel is supported by the frame on one side or two sides thereof.

10. The refrigerator according to claim 8, wherein the frame comprises a panel seating part that supports the decorative panel, and
the panel seating part supports a lower surface of an end of the decorative panel and the stepped part compensation member but does not support a side surface and an upper surface of the end of the decorative panel.

11. The refrigerator according to claim 8, wherein the frame comprises a panel seating part and a position fixing protrusion that support the decorative panel,
the panel seating part supports a lower surface of an end of the decorative panel and the stepped part compensation member, and
the position fixing protrusion supports a side surface of the end of the decorative panel but does not support an upper surface of the decorative panel.

12. The refrigerator according to claim 1, wherein the frame is integrally injection-molded.

13. The refrigerator according to claim 1, wherein the frame is an assembly constructed by a plurality of chasses.

14. A method of manufacturing a refrigerator having a door that opens and closes a storage chamber, wherein the door comprising:
a frame;
a decorative panel supported by the frame; and
a decoration unit supported by the decorative panel, and
the decoration unit is fixed to the decorative panel and the decorative panel is fixed to the frame by a bonding force of a foamed material.

15. The manufacturing method according to claim 14, wherein the decoration unit is temporarily fixed to the decorative panel by a dedicated adhesive material before being fixed by the foamed material.

16. The manufacturing method according to claim 14, wherein the decorative panel is temporarily fixed to the decorative panel by a dedicated adhesive material before being fixed by the foamed material.

17. A refrigerator comprising:
a main body containing a storage chamber; and
a door opening and closing the storage chamber;
wherein the door comprises:
a frame; and
a panel fixed to the frame, and
wherein the panel is sequentially fixed to the frame by an adhesive material and a foamed material, in this order, and is disposed at a front side of the frame, to prevent the front side of the frame from being exposed.

18. The refrigerator according to claim 17, wherein the frame comprises a panel seating part supporting the panel, and
the panel seating part supports a lower surface of the end of the panel but does not support a side surface and an upper surface of the panel when the end of the panel is supported by the frame on one side thereof.

19. The refrigerator according to claim 18, wherein the side surface of the panel and a side surface of an end of the frame are coplanar.

20. The refrigerator according to claim 17, wherein the frame comprises a panel seating part and a position fixing protrusion which support the panel, and
when the panel is supported by the frame on two sides thereof, the panel seating part supports a lower surface of the end of the panel, and the position fixing protrusion supports a side surface of the end of the panel but does not support an upper surface of the panel.

21. The refrigerator according to claim 20, wherein the upper surface of the end of the panel and an upper surface of an end of the frame are coplanar.

22. The refrigerator according to claim 17, wherein the panel comprises a decorative panel mounted to a front side of the frame.

23. The refrigerator according to claim 17, further comprising a decoration unit disposed at a rear surface of the panel.

24. The refrigerator according to claim 23, wherein the decoration unit comprises:
a jewel member or a light emission member; and
a supporting plate fixed to the panel while supporting the jewel member or the light emission member.

25. The refrigerator according to claim 17, wherein the panel comprises a flat part and a rolled part stepped with respect to the flat part, and further comprises a stepped part compensation member mounted along the rolled part to compensate for the stepped part.

26. The refrigerator according to claim 25, wherein the rolled part and the stepped part compensation member are supported by the frame.

27. The refrigerator according to claim 17, wherein the panel is fixed to the frame by a bonding force of the foamed material.

28. A refrigerator comprising:
a main body containing a storage chamber; and
a door opening and closing the storage chamber;
wherein the door comprising:
a frame;
a panel fixed to the frame; and
a position fixing protrusion to guide the panel to a position where the panel is to be seated, and
wherein the panel is sequentially fixed to the frame by an adhesive material and a foamed material, in this order, and the position fixing protrusion has a height equal to or smaller than a height of the panel.

29. A method of manufacturing a refrigerator having a door that opens and closes a storage chamber, wherein the door is constructed by:
supporting a decoration unit on a decorative panel; and
supporting the decorative panel on a frame, and
the decoration unit is fixed to the decorative panel and the decorative panel is fixed to the frame by a bonding force of a foamed material.

30. A refrigerator having at least one door, the door comprising:
a frame;
a front panel supported by the frame; and
a foamed material that fixes the front panel to the frame, wherein,
the front panel is temporarily joined to the frame by a temporary joining member before being fixed by the foamed material without further fixing members to the frame.

31. The refrigerator according to claim 30, wherein the refrigerator further comprises a decoration unit which is joined to the back of the front panel by a temporary joining member before the foamed material fixes the front panel to the frame.

32. The refrigerator according to claim 30, wherein the front panel is made of substances including wood, tempered glass, acrylic, aluminum, and steel plate.
